(19) United States
(12) Patent Application Publication
(10) Pub. No.: US 2013/0007089 A1
(43) Pub. Date: Jan. 3, 2013

(54) DISTRIBUTING POINTS OF INTEREST

(76) Inventors: Cornelius J. O'Donnell, San Marcos, CA (US); James Bradford Trask, San Diego, CA (US); Lakshmi Sri Jyothsna Chunduri, San Diego, CA (US)

(21) Appl. No.: 13/171,554

(22) Filed: Jun. 29, 2011

(51) Int. Cl. G06F 15/16

(52) U.S. Cl. 709/201

(57) ABSTRACT

Example embodiments disclosed herein relate to distributing points of interest. One of multiple points of interest is determined based on a distance analysis of the points of interest. A cluster of the points of interest are determined. The points of interest of the cluster are distributed to map sets based on a statistical analysis.

### BACKGROUND

Service providers and manufacturers of devices are challenged to deliver quality and value to consumers, for example by providing mapping services. Such mapping services include providing information about points of interest. The information about the points of interest can include information associated with where the respective points of interest are located. Further, the respective points of interest can be associated with description information. The mapping services can be provided in a variety of ways, for example, one mapping service can provide mapping on a device (e.g., a global positioning system device) while another mapping service can be associated with the use of paper maps.

### BRIEF DESCRIPTION OF THE DRAWINGS

The following detailed description references the drawings, wherein:

FIG. 1 is a block diagram of a system including a device to associate a set of points of interest to maps, according to one example;

FIGS. 2A and 2B are block diagrams of devices capable of associating points of interests to maps, according to various examples;

FIG. 3 is a flowchart of a method for distributing points of interests to maps based on a statistical analysis, according to one example;

FIG. 4 is a flowchart of a method for distributing points of interests to maps, according to one example;

FIGS. 5 and 6 are block diagrams of maps showing the location of points of interest, according to various examples;

FIGS. 7A-7D are block diagrams showing the distribution of maps covering an area, according to various examples;

FIG. 8 is a block diagram of a map showing a distribution of maps, according to one example; and

FIG. 9 is a block diagram of a computing device for distributing points of interest of a set to maps based on a spread of the points of interest, according to one example.

### DETAILED DESCRIPTION

People are on the move and travel to various places every day. These places can be local or to travel destinations (e.g., for a trip). Guide books and other documents can be used to provide information about the places and/or help a user decide on a place to go to. Places people decide to travel to generally are associated with one or more points of interest (POIs). In certain embodiments, a POI is a specific location that a person may find interesting or useful. Examples of POIs include a restaurant, a bakery, an airport, a landmark, a hotel, etc. Thus, a POI can be any point that is interesting, useful, or significant in some way.

Maps are an important feature of traditional static travel guide books. However, static print maps cannot handle variable data. Thus, it would require manual effort to construct good, quality maps for customized guide books. Variable content maps, such as those used in global positioning system (GPS) mapping and online mapping services generally center on a single POI and then show other POIs that are nearby. However, this approach would not be useful to generate a variable content guide book of an area because the POI is not known ahead of time.

Accordingly, various embodiments disclosed herein relate to distributing POIs to maps. These maps can be used to generate a customized guide book for users. As such, the guide book can include POIs that are useful to a particular user. Distribution of the POIs to maps can pose technical challenges because the zoom level of the map, the size of the map, and the distribution of the POIs may need to change to provide a map that is viewable by a user. For example, it can be advantageous to use an appropriate zoom level where POIs are spaced to provide meaningful location information. This can be performed by zooming in on POI dense areas and zooming out on POI scarce areas. Another advantageous characteristic can include including a large number of POIs per map in a set of maps used to generate the guide book. As such, fewer maps may be required to show the POIs in a particular area. Thus, a user looking at the guide book can make sense of the maps. Cluster analysis as well as distance statistics can be combined with decision lookup tables, map zoom level calculations, etc. to generate the guide book. In certain embodiments, a guide book is a manual to help a user understand a location. The guide book can be physical (e.g., a printed book), electronic (e.g., a computer file including guide book information), or the like. The guide book can include one or more maps displaying one or more POIs. Further, information about the POIs can be included in the guide book.

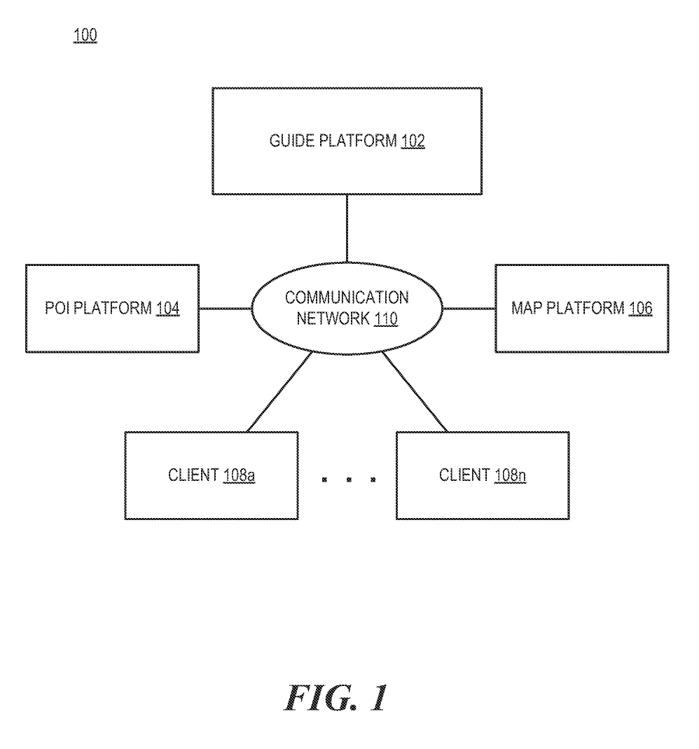

FIG. 1 is a system diagram of components to generate a set of maps with associated POIs, according to one example. The system 100 can include a guide platform 102 that communicates with a POI platform 104, a map platform 106, clients 108a-108n, and other devices via a communication network 110. In certain examples, the guide platform 102, the POI platform 104, the map platform 106, and the clients 108 are computing devices, such as servers, client computers, desktop computers, mobile computers, etc. The guide platform 102, the POI platform 104, the map platform 106, and the clients 108 can be implemented via a processing element, memory, and/or other components. The map platform 106 can be within the same system (e.g., have the same provider and/or be implemented on the same computing devices) as the POI platform 104 or a different system. Further, the guide platform 102 can be implemented as a single computing device or as a group of computing devices of a system or cloud.

The guide platform 102 can provide a customization interface, such as a web interface or an application programming interface (API) to allow users of clients 108 to customize guide books including POIs and maps. Clients 108 can access the interface via the communication network 110. A client 108 can provide a user with options to customize the user's experience to generate the guide book. For example, the user may be able to answer travel related questions, provide lodging details, or provide other details that may be useful in determining which POIs the user would be interested in. In one example, the POIs can be associated with a rating based on questions asked to the user. One such question would be how interested the user is in landmarks, museums, restaurants, etc. Another question may be to determine what cost the user is willing to pay. For example, one user may be on a corporate budget and would like to go to more expensive restaurants, while another user may be on a family travel budget that would be more interested in visiting less expensive sit down restaurants. Answers to such questions can be used to determine a set of POIs in the area that the user may be interested in knowing more information about.

The guide platform 102 can query the POI platform 104 to retrieve information about POIs. This information can be used to determine the set of POIs. Further, the guide platform 102 can generate a decision lookup table including rankings associated with the POIs in the set. Information about the POIs can be associated with location information. The location information can include a longitude and/or latitude, coordinates such as GPS coordinates, street addresses, or the like.

Coordinates of the POIs can be used to determine spacing between POIs as well as distribution of POIs to maps. This can be based on a distance analysis. In one example, coordinates are used to compute the distance from each POI to every other POI. A table or other data structure can be used to store the information. Then, the guide platform 102 determines one of the POIs. The POI can be the POI with the most number of other points within a predetermined distance D. If there is a tie, a tiebreaker can be based on criteria. For example, the POI more relevant based on the decision lookup table can be selected.

Then, a cluster of the POIs of the set can be determined. This cluster can be determined based on the distance D. For example, the cluster can include each of the POIs within D of the determined POI. The amount of POIs in the cluster can be considered a POI count.

The guide platform 102 can then determine how many maps should be used to distribute the POIs of the cluster. In one example, this can be based on a variable of how many POIs should be showed on a map. This variable can be determined by a user, can be based on a maximum amount of POIs to present based on the map platform 106, or the like. Further, the variable can be dynamic for each map. In this scenario, a range can be provided with a minimum and maximum allowable POIs per map. For example, if there is a POI count of 45 and the variable range is between 12 and 16, a map count of 3 would be determined.

Then, guide platform 102 can decide the number of POIs that should be in each map. In one scenario, the POIs are distributed evenly across maps, the remainder also distributed evenly. For example, if the variable is 15, the POI count is 40, and the map count is 3, the POI distribution would be [14, 13, 13]. In another scenario, the variable could be ranged. In this scenario, a variable number of points can be determined for each map. As such, the variable range can be from 10-15 and various POI set distributions can be performed. For example, in the previous scenario, the set could be [15, 13, 12], [15, 14, 11], [14, 13, 13], etc. The number of POIs that should be distributed in each map can also be variable based on other information, such as the layout of the maps.

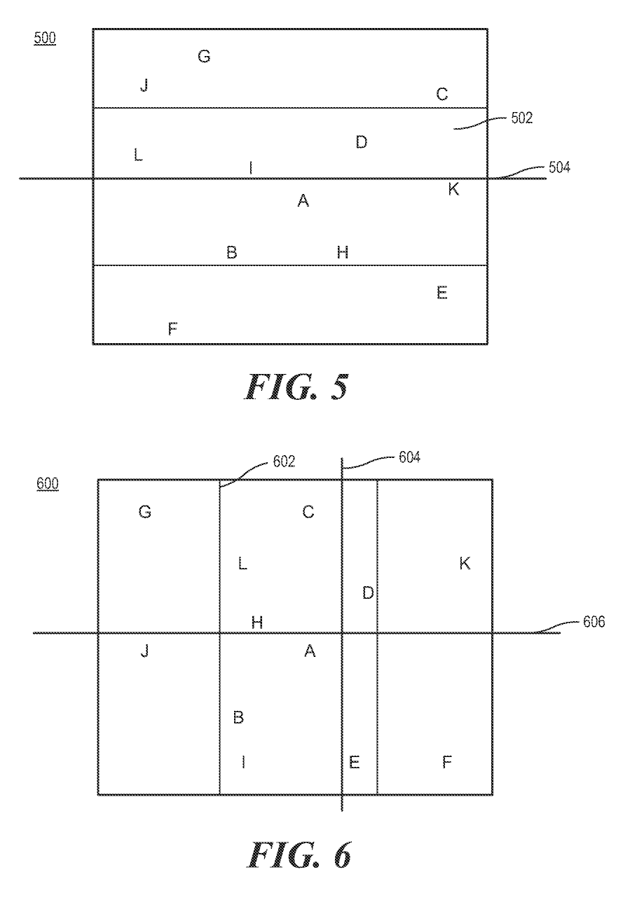

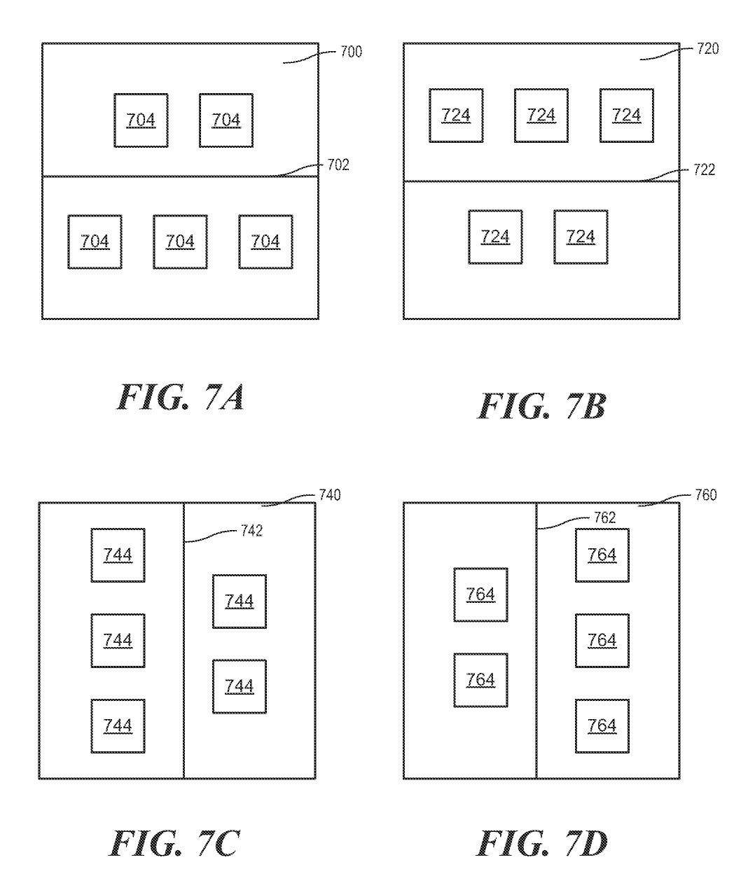

A statistical analysis can be performed on the POIs of the cluster determine a layout as further detailed in FIGS. 5-7D. A spread analysis can be performed on the POIs to determine how spread out the POIs are based on longitude and latitude coordinates. If the POIs are more spread out across latitudes, then the layout is vertical. If the POIs are more spread out across longitudes, then the layout is horizontal. These spreads can be determined based on the standard deviation and/or mean of the POIs. The total number of maps can be used to determine each of the possible layouts as further discussed in FIGS. 7A-7D. The maps can be zoomed based on the layout sizes and the arrangements of POIs to be presented. POIs can additionally be distributed between maps based on the decision lookup table, where the most relevant POIs are chosen first.

Further, once maps are generated, additional POIs from the first set of POIs that are not in the cluster can be added to the cluster. This may occur if the POIs would be present in the chosen maps, even if the POIs are not within distance D of the selected POI. The distance and statistical analysis can be performed again with the updated cluster of POIs.

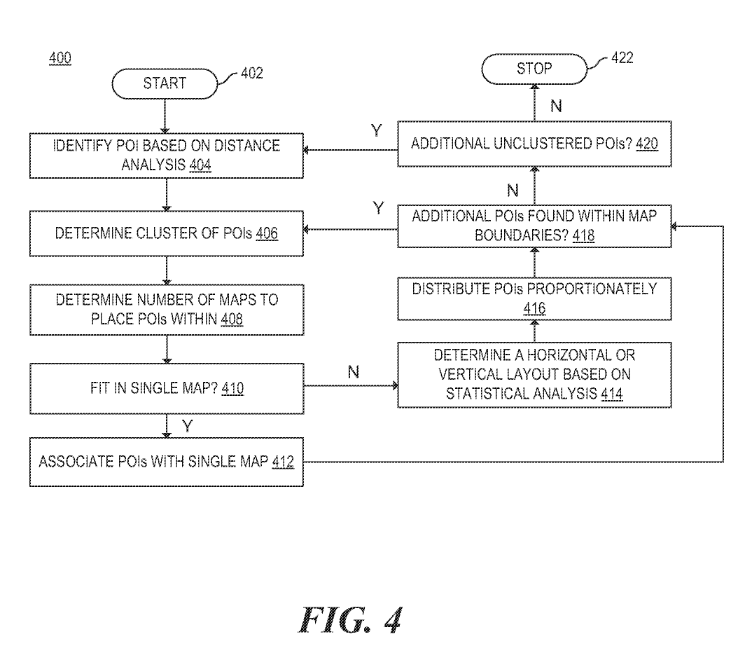

Further, once a cluster is distributed to maps, the analysis can be performed on another POI of the set that is not in the cluster. As such, another cluster can be formed based on that POI and the cluster can be distributed to maps based on the analysis as further detailed in FIG. 4. Multiple other POIs can be selected based on this procedure. Further, the distance D to determine the clusters and/or select POIs can change. As iterations of looking for clusters and distributing the cluster POIs to maps go further, the distance D for each iteration can increase. For example, the first two iterations can look for POIs within a distance of 1 mile from the identified POIs, the third iteration can look for POIs within 2 miles, etc. Further, the distance D for each iteration can be dynamic. For example, the distance D may increase if fewer POIs are left that can be clustered. In one scenario, if the number of POIs within range of the identified POI is less that a particular count, the distance can be incremented and the search for the cluster restarted. The particular count can be static or dynamic. For example, the particular count may be a percentage of the total POIs or of the total amount of POIs that can be distributed to a single map. In certain scenarios, when there are a certain amount of POIs left that have not been clustered, a catchall map can be generated to show the remaining POIs.

Additional processing can be performed. For example, the distance analysis and statistical analysis can be performed for each combination of map counts, POIs per map, and map layout that can be used for the cluster. For each permutation, the group of maps that describe the permutation can be determined. Quality statistics can be used to determine a quality score for each map group. Then, the map group with the best quality score can be used.

Various criteria can be used to generate a quality score for the map groups. Some criteria takes into account individual area associated with the maps of the group. For example, it may be advantageous to have a smaller area or focus for each map, thus a map group would score better if the average individual area is determined to be smaller. Further, it may be advantageous for the maps to be roughly the same size, thus a smaller standard deviation of the areas of the individual maps would score higher. In a similar manner, it can be advantageous for the entire area of the maps in the respective groups to have smaller area. These map groups can score better. In certain scenarios, there is a catch all map, these maps may not be scored for this criterion or other criteria.

Other criteria can include zoom levels. As noted above, it is better to have a smaller area or focus, which leads to more spread out POIs. As such, a zoom level average indicating that the zoom level is more zoomed in would score better. Further, a lower value for a zoom level standard deviation would score better because it would be aesthetically pleasing to have the maps zoomed in at about the same level.

Further, criteria can include measures of the shape of the maps. For example, the average width to height percentage difference could be used to score the map groups. Square maps may score better because more area can be viewed with particular zoom boundaries. This may change based on other information (e.g., the shape of a guide book for which the maps are generated).

Other criteria can include the spacing of the maps. For example, less total overlap between maps would be score better. Moreover, it can be advantageous for the total area between maps to be larger. Thus map groups with a larger total area between maps can be scored better. The advantage in this case is that less area is covered that is not associated with POI. As such, more focus is on map areas associated with POIs.

The spread of POIs on individual maps can also be rated. For example, map groups with average standard deviation of latitude and/or longitude for individual maps that are greater can be scored better. This can be to reflect that POIs spread across the individual maps rather than tightly clustered is advantageous. In a similar manner, distance between points, on average, can be used as criteria. As such, map groups with a greater spread of POIs across individual maps rather than tightly clustered would score better. Combinations of these criteria can be used to score or otherwise rate the map groups. The best map group can be selected.

The communication network 110 can use wired communications, wireless communications, or combinations thereof. Further, the communication network 110 can include multiple sub communication networks such as data networks, wireless networks, telephony networks, etc. Such networks can include, for example, a public data network such as the Internet, local area networks (LANs), wide area networks (WANs), metropolitan area networks (MANs), cable networks, fiber optic networks, combinations thereof, or the like. In certain examples, wireless networks may include cellular networks, satellite communications, wireless LANs, etc. Further, the communication network 110 can be in the form of a direct network link between devices. Various communications structures and infrastructure can be utilized to implement the communication network(s).

By way of example, the guide platform 102, the POI platform 104, map platform 106, and clients 108 can communicate with each other and other components with access to the communication network 110 via a communication protocol or multiple protocols. A protocol can be a set of rules that defines how nodes of the communication network 110 interact with other nodes. Further, communications between network nodes can be implemented by exchanging discrete packets of data or sending messages. Packets can include header information associated with a protocol (e.g., information on the location of the network node(s) to contact) as well as payload information. A program or application executing on the components can utilize one or more layers of communication to utilize the messages.

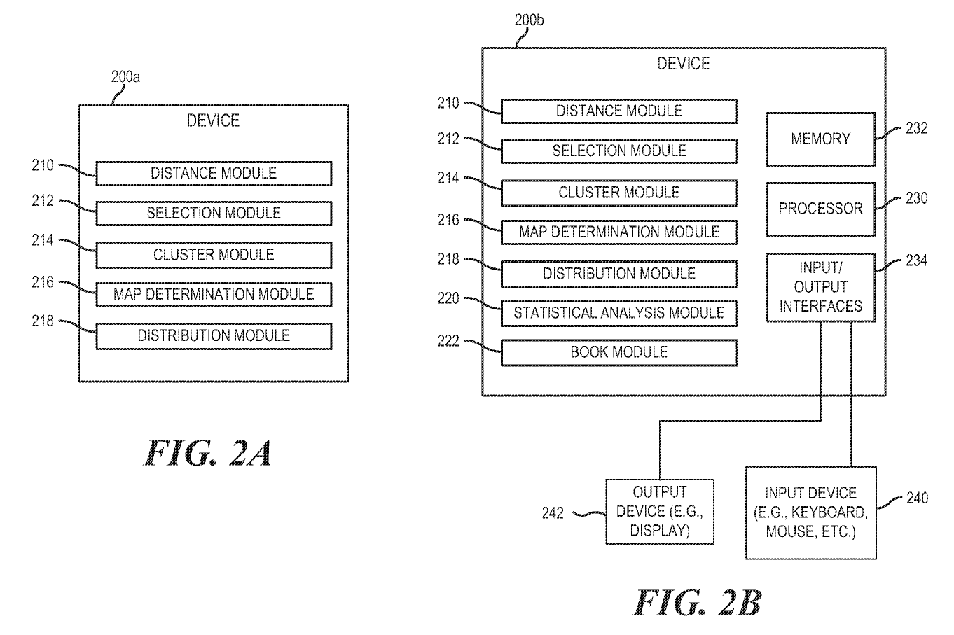

FIGS. 2A and 2B are block diagrams of devices capable of associating points of interests to maps, according to various examples. Devices 200a, 200b include components that can be utilized to associate POIs with maps. Further, devices 200a, 200b and/or modules of the devices 200a, 200b can be used to implement a guide platform. The respective devices 200a, 200b may be a notebook computer, a desktop computer, a wireless device, a server, a workstation, or any other computing device that can associate POIs to maps.

The device 200 can receive a request for a guide book. The request can include one or more preferences and/or POI criteria that can be used to generate the guide book. The preferences and/or POI criteria can include information about answers to questions, for example, about what kinds of POIs would be relevant to the user. Additionally or alternatively, the preference and/or criteria can be preselected and/or selectable. For example, one or more default options can be provided. Further, the request can specify an area for which to generate the guide book. The area may be selected, for example, by selected boundaries, a zip code, coordinates, a selected travel destination, or the like.

As noted above, the device 200 can query a POI platform for POI information about the area. The POI information as well as the POI criteria is used to determine an initial set of POIs. Further, information about the POIs can include coordinate information that can be used to determine relationships between the POIs.

A distance module 210 can determine a distance between each of the POIs and each of the other POIs. As noted, the POIs can be respectively associated with coordinates. The distance module 210 can further generate a data structure (e.g., a table) to store the distance information associated with the POIs.

A selection module 212 can then be used to select one POI from the set of POIs. The selection can be based on a distance analysis. For example, a threshold distance can be used to select the one POI. The one POI can be the POI with the most number of other POIs within the threshold distance of the POI. In the case that there is more than one POI with the same amount of POIs within the threshold distance, other criteria, for example, the POI criteria and/or POI preferences can be used to select the one POI. Other methods can be used to help determine the one POI such as the name of the POI, the type of the POI, etc.

A cluster module 214 can determine a cluster of the POIs that is within a predetermined distance of the one POI. In certain scenarios, the predetermined distance is the threshold distance. Other manners can be used to determine the cluster, for example, using the threshold distance to determine a bounded area (e.g., bounded by a circle, a square, a rectangle, a pentagon, etc.). The threshold distance can be used to determine the bounded area by determining a radius, a side length, etc. of the bounded area. The POIs that are located within the bounded area can be associated with the cluster. This can form two groups, the cluster group including the cluster POIs and the group that represents the set of POIs that are not in the cluster group. In certain embodiments, cluster POIs are POIs that are associated with a particular cluster.

A map determination module 216 determines an amount of maps to distribute the cluster POIs. The map determination module 216 can determine the number of maps based on the number of cluster POIs and a number of POIs to present per map. The number of POIs to present per map can be a static number or can be a variable number. As noted previously, the number can represent a maximum number of POIs to distribute (e.g., based on a technical capacity, a preference, etc.). The amount of maps may be determined by dividing the total POIs in the cluster by the number. The smallest amount of maps that can fit all of the POIs can be used. As such, if there are 50 POIs and the number is 18, a total of 50/18=3 maps rounded up are used.

A distribution module 218 distributes the cluster POIs to the maps based on a statistical analysis. A statistical analysis module 220 can help determine the distribution. The coordinates of the cluster POIs can include a horizontal coordinate and a vertical coordinate. These can be longitude and latitude coordinates, GPS coordinates, Cartesian coordinates, and/or other types of coordinates. The statistical analysis module 220 determines a horizontal spread and a vertical spread. This can be accomplished, for example, by determining a horizontal standard deviation based on the vertical coordinates and a vertical standard deviation based on the horizontal coordinates. In one example, a layout is horizontal if the horizontal standard deviation is greater than and/or equal to the vertical standard deviation. In another example, the layout is vertical if the vertical standard deviation is greater than and/or equal to the horizontal standard deviation. A split can be formed, as further detailed in FIGS. 5 and 6 based on the layout. The distribution of the cluster POIs to the maps can be based on the split. For example, if the split is vertical, maps can cover POIs on each side of the split.

The POIs can be proportionately distributed on sides of the split. The location of the split can be based on the locations of the POIs. In one example, the number of maps is even. As such, the split can be formed in a manner such that each map has a proportionate amount of POIs and are on opposite sides of the split. In another example, the number of maps is odd. In this scenario, the split can be weighted so that one side can support an extra map. In the above example of 50 cluster POIs, 3 maps, and a maximum of 18 POIs per map, the POIs can be split. So that two maps can be associated with POIs on one side of the split and one map is associated with the POIs on the other side of the split.

Then, with the remaining non-cluster POIs, the distribution module 218 can select another POI based on distance analysis. Then another cluster associated with the other selected POI can be generated and maps can be determined for the other cluster as described above. Additional clusters can be determined and additional maps can be determined with remaining POIs. Further, the threshold distance can be changed (e.g., increased) for each cluster. In certain scenarios, if an insufficient amount of POIs are found for the cluster, the threshold distance is increased. Further, when a certain number of POIs are left, a catchall map can be used to encompass the remaining POIs.

When the POIs are distributed to the maps, a book module 222 can generate guide book information including the maps. Each map can show its distributed POIs. Further, the guide book information can include description information for each of the POIs. Descriptions can include information about the location of the POI, the type of POI, the history of the POI, ratings of the POI, or the like. With this approach, maps populated with POIs can be determined for generation of the customized guide book. The book information can be stored as a file, for example, as a rich text document, a portable document format (PDF) document, a set of images, a web document, or the like. The book information can further include additional information, such as advertisements, pictures of locations and/or POIs, or the like. Further, the book information can be printed out to generate a physical guide book.

A processor 230, such as a central processing unit (CPU) or a microprocessor suitable for retrieval and execution of instructions and/or electronic circuits can be configured to perform the functionality of any of the modules 210-222. In certain scenarios, instructions and/or other information, such as lookup tables, POI information, maps, etc., can be included in memory 232 or other memories. Input/output interfaces 234 may additionally be provided by the device 200b. For example, input devices 240, such as a keyboard, a mouse, a microphone, etc. can be utilized to receive input from an environment surrounding the device 200b. Further, an output device 242, such as a display, can be utilized to present information to users. Examples of output devices include speakers, display devices, amplifiers, printers, etc. Moreover, in certain embodiments, some components can be utilized to implement functionality of other components described herein. Input and output devices, such as network devices, storage, etc. can also be connected via the input/output interfaces 234.

Each of the modules 210-222 may include, for example, hardware devices including electronic circuitry for implementing the functionality described below. In addition or as an alternative, each module 210-222 may be implemented as a series of instructions encoded on a machine-readable storage medium of device 200 and executable by processor 230. It should be noted that, in some embodiments, some modules are implemented as hardware devices, while other modules are implemented as executable instructions.

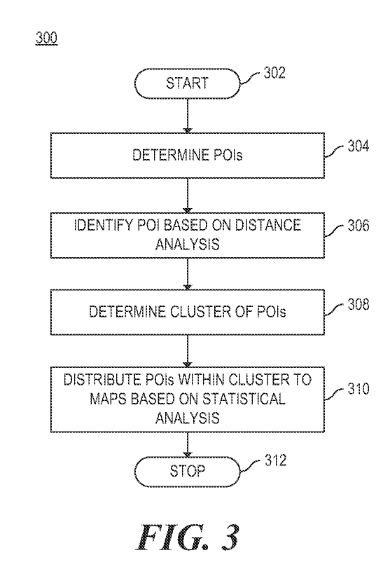

FIG. 3 is a flowchart of a method for distributing points of interests to maps based on a statistical analysis, according to one example. Although execution of method 300 is described below with reference to device 200b, other suitable components for execution of method 300 can be utilized (e.g., device 200a, computing device 900, guide platform 102, etc.). Additionally, the components for executing the method 300 may be spread among multiple devices. Method 300 may be implemented in the form of executable instructions stored on a machine-readable storage medium and/or in the form of electronic circuitry.

Method 300 may start at 302, where the device 200b can be in a state where the device 200b is requested to generate a group of maps with associated POIs. The maps may be used, for example, to generate a guide book. Further, the device 200b may have access to a decision lookup table associated with a requestor. The decision lookup table can be customized based on questions asked to the requestor. Moreover, the device 200b can have access to information about an area to associate with the maps. For example, the guide book can be associated with Washington, D.C. and the area can be a metropolitan area associated with Washington, D.C. Further, the area can be modified based on a options provided to the requestor.

Method 300 may then proceed to 304, where device 200b may determine a plurality of POIs. The POIs can be predetermined (e.g., default), provided by a user, provided by the request, determined based on the area, or the like. The POIs can be associated with coordinates, such as horizontal coordinates like longitude coordinates and vertical coordinates like latitude coordinates. An analysis of the coordinates can be used to determine distribution of the POIs to maps. Further, the maps can be formed based on the distribution of POIs.

At 306, the device 200b can identify one of the POIs based on a distance analysis of the POIs. The distance analysis can include a distance module 210 determining, for each of the POIs, respective numbers of the POIs within a distance D of the respective other POIs. The distance D can be variable, incremented, etc. The identified POI can be identified based on a determination that the number of POIs within the distance D of the identified POI is greater than or equal to the other respective numbers of POIs within the distance of the other POIs. If there is a tie in the number of POIs within the distance D between two or more POIs, other criteria can be used to identify the POI. For example, alphabetical order can be used, the decision lookup table can be used, a rating associated with the POI can be used, or the like.

The method 300 then proceeds to 308, where the cluster module 214 determines a cluster of the POIs. In one example, the cluster includes a set of the POIs that are within the distance D. In another example, the cluster can include a set of the POIs that are determined based on the distance D in another way. For example, the set can include POIs that are within a square or rectangle area with an edge or cross section being associated with the distance D.

Then, at 310, the distribution module 218 can distribute the POIs within the cluster to a plurality of maps based on a statistical analysis. The statistical analysis is further described in FIGS. 4-7D and may involve the distribution of the POIs to map sections. The determination can be based on coordinate analysis and maps need not be generated at the time of distribution. For example, map boundaries can be determined based on POI distribution and then the maps can be retrieved from a map platform. As such, distribution of the POIs to maps can include distributing the POIs to map boundaries.

Then, at 312, the method 300 stops. Other processes can be completed by the device 200b after the method 300 stops. For example, the maps can be determined based on the POI distributions (e.g., by requesting a bounded map from a map platform). Also, a book module 222 can be used to generate book information including the maps with the respectively distributed POIs and content respectively describing the distributed POIs. The book information may also include maps associated with additional clusters of POIs. The book information can be stored in one of a plurality of files (e.g., PDF format, a web format, etc.). Further, the book information can be used to generate a guide book by printing out the book information.

FIG. 4 is a flowchart of a method for distributing points of interests to maps, according to one example. Although execution of method 400 is described below with reference to device 200b, other suitable components for execution of method 400 can be utilized (e.g., device 200a, computing device 900, guide platform 102, etc.). Additionally, the components for executing the method 400 may be spread among multiple devices. Method 400 may be implemented in the form of executable instructions stored on a machine-readable storage medium and/or in the form of electronic circuitry.

Method 400 may start at 402 at a state where a set of POIs have been determined. The set can be based on customization information. Further, a relevance decision table can be generated based on the customization information for the set of POIs. The method 400 proceeds to 404, where device 200b identifies a POI of the set based on a distance analysis. An example of the decision analysis is block 306 of method 300. Then, at 406, a cluster module 214 determines a cluster of the POIs. The cluster can be based on a threshold distance used to identify the POI. In one example, the cluster can include POIs within the threshold distance of the identified POI. In another example, the cluster can include POIs within a boundary determined by the threshold distance. The boundary can be, for example a square or other shape that is determined by the identified POI and the threshold distance.

At 408, a map determination module 216 determines a number of maps to distribute the cluster POIs to. As previously noted, this can be implemented by having a variable that indicates a particular number of POIs to place in a map. The variable can be a maximum number of POIs to associate with the maps. As such, the map determination module 216 determines a count of the maps based on a maximum number of POIs to associate with the respective maps. At 410, a distribution module 218 determines whether a single map can fit the cluster POIs or if multiple maps should be used. If a single map can be used, at 412, the cluster POIs are associated with a single map. As such, the map determination module 216 can determine the boundaries of the map areas associated with the cluster of POIs. The method 400 then continues at 418.

If the distribution module 218 determines that multiple maps should be used to distribute the POIs of the cluster, method 400 proceeds to 414, where a layout of the POIs is determined. Each of the POIs of the cluster can correspond to a horizontal coordinate and a vertical coordinate. As such, a statistical analysis module 220 can determine a horizontal spread based on the vertical coordinates and a vertical spread based on the horizontal coordinates. An example approach to determine a spread is to perform a standard deviation on the coordinate values. As noted above, a comparison of the spreads determines whether the layout is horizontal or vertical. As further discussed in FIGS. 5-7D, the layout corresponds to a splitting of the POIs of the cluster into map sets, where each map to be generated includes POIs in a map set. For example, the distribution module 218 can determine a directional split based on the horizontal spread and the vertical spread.

Then, at 416, the distribution module 218 distributes the cluster POIs to the maps proportionately. Thus, in the case of an even number of maps, the number of POIs on each side of the split can be equal or close to equal (e.g., if there are an odd number of cluster POIs, one side of the split has N POIs and the other side has N+1 POIs). The location of the split can be determined based on various methods. One method can be to choose a location that is a mean or median of the coordinates used to determine the split. Another method can be to choose a split location that allows for the proper number of maps to incorporate the proper number of POIs. For example, if there are 20 POIs in the cluster to be distributed to 2 maps, the split can be determined in a manner such that 10 POIs are located on each map. In certain scenarios, this can lead to an overlap in the maps to cover the same amount of POIs.

In the case that the map count is odd, additional analysis can be performed. For example, the distribution module 218 and/or the statistical analysis module 220 can determine a weighting of the POIs in relation to the directional split as further detailed in FIGS. 5-7D. As such, the side of the directional split with a greater weighting has more of the maps than the other side of the directional split. Once the POIs are distributed proportionately, a zoom level and map boundaries can be determined for each of the maps.

Then, at 418, the cluster module 214 can determine whether additional POIs are found within the map boundaries. If there are additional POIs found, the method 400 can return to 406 to determine an updated set of cluster POIs that include the POIs within the map boundaries of the determined maps. Then, the method can continue using the updated cluster POIs until block 418 is reached. If there are no additional POIs in the cluster, the method 400 continues to 420.

At 420, the selection module 212 determines whether there are unclustered POIs. The clustered POIs are taken out of the set of POIs that are used. Then the method 400 returns to 404 to perform another analysis based on the unclustered POIs. As such, a first one of the unclustered POIs is identified based on a distance analysis of the POIs of the unclustered POIs. Then, another cluster is determined based on the unclustered POIs. The other cluster can be based on a particular distance and the identified unclustered POI. The method can continue until block 420 once again to distribute the unclustered POIs to other maps.

This method 400 can be repeated until a break condition occurs. The break condition can include a determination at 420 that no additional unclustered POIs are remaining. Further, another stop condition can include a determination that the remaining POIs unclustered can fit in to a single map. This catchall map can include the remaining POIs and the method 400 can stop at 422.

The device 200b can continue to perform other processes. For example, the device 200b can determine the contents of the maps. Further, a book module 222 can generate book information including the maps with the respectively distributed POIs and content describing the POIs. The book information can be represented digitally. Further, the book information can be printed out to generate a physical guide book.

FIGS. 5 and 6 are block diagrams of maps showing the location of points of interest, according to various examples. Map 500 shows multiple POIs, POIs A-L, in a provided area. These POIs can be the POIs in a particular cluster. Further, in certain examples, the POIs can be determined based on proximity to POI A. When determining to distribute the POIs into maps, a distribution module of a device can determine a layout associated with the cluster. The layout 502 can be based on a statistical analysis of the location of the POIs. In one example, if the POIs are more spread out across horizontal coordinates (e.g., longitudes), the layout is horizontal. One method of determining the spread is to determine the latitude standard deviation and longitude standard deviation. If the latitude standard deviation is <=longitude standard deviation, the layout is horizontal.

The layout 502 in this scenario is horizontal. As noted above, the number of POIs and a variable (e.g., maximum POIs per map) can be used to determine the number of maps to distribute the POIs to. In one example, the number of maps for this case can be two maps. As such, the POIs can be split evenly according to a horizontal split. In this scenario, two sets of POIs can include [C, D, G, I, J, L] and [A, B, E, F, H, K] split at split line 504. In another example, the number of maps can be three. As such, the POIs can be split according to weighting as further detailed in FIGS. 6, 7A-7D.

In the example of FIG. 6, map 600 is determined to be a vertical layout 602. In this example, the number of maps is 3, where the maximum number of POIs per map is 4. In this scenario, a determination is made as to whether the POIs are weighted towards the left or towards the right side of the map 600. In this scenario, the POIs are towards the left side. As such, a split line 604 is determined in such a manner that one map can be used on the right side and two maps can be used on the left side. Further, POIs [D, E, F, K] can be included in a first map. The POIs on the left side are then distributed proportionally based on location. As such, another split line 606 can be determined creating a map including POIs [A, B, I, J] and [C, G, H, L]. The examples in FIGS. 5 and 6 are for illustrative purposes. It is intended that additional POIs can be used and that more than two or three maps can be used.

FIGS. 7A-7D are block diagrams showing the distribution of maps covering an area, according to various examples. In these examples, the number of maps to cover the POIs in the respective areas 700, 720, 740, 760 is an odd number (5). The layouts for each area 700, 720, 740, 760 are split according to respective split lines 702, 722, 742, 762 based on a spread of the POIs. When the number of maps to use is uneven, an analysis can be performed to determine how heavy respective layouts are.

In certain examples, a layout is heavy on a particular side if there are more POIs on a particular side of a layout orientation. In one example, a horizontal layout like in FIGS. 7A and 7B can be bottom heavy (e.g., FIG. 7A) or top heavy (e.g., FIG. 7B). In these scenarios, if an average of the latitudes (vertical coordinates) is <=to the latitude midpoint, the layout is bottom heavy. Thus, if the latitude average is greater than the latitude midpoint, the layout is top heavy. If the POIs are heavier on a particular side, the layout can be distributed in such a manner in which an additional map is used for that side. In one example, because FIG. 7A is bottom heavy, an additional one of the maps 704 is used on the bottom side of the split line 702. In another example, because FIG. 7B is top heavy, an additional one of the maps 724 is used on the top side of the split line 722. The location of the split line can change to correspond with the distribution.

In another example, a vertical layout like in FIGS. 7C and 7D can be left heavy (e.g., in FIG. 7C an extra one of the maps 744 is distributed to the left) or right heavy (e.g., in FIG. 7D an extra one of the maps 764 is distributed to the right). In these scenarios, if an average of the longitudes (horizontal coordinates) is <=the longitude midpoint, the layout is left heavy. Further, if the longitude average is >the longitude midpoint, the layout is right heavy. The determination of which side includes the midpoint can be implementation based. Moreover, in these examples, the longitude coordinates increase moving right and the latitude coordinates increase moving up.

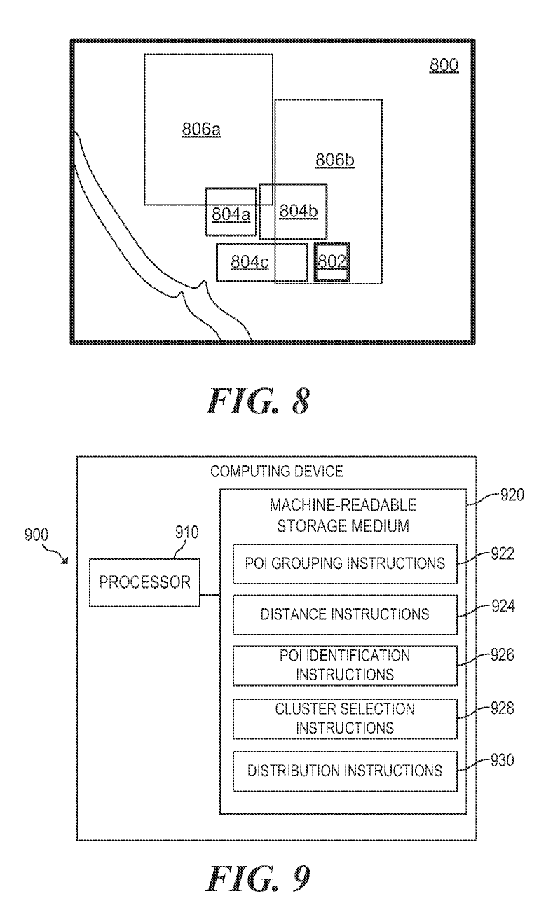

FIG. 8 is a block diagram of a map showing a distribution of maps, according to one example. FIG. 8 shows an area 800 in which maps based on clusters are determined. The distribution can be based on method 400. In this example, a first cluster is determined with a first distance threshold. The map of this first cluster is map 802. The distance threshold for this iteration is low. As such, a smaller area is covered in map.

In a second iteration of method 400, a distribution of the cluster includes POIs corresponding to the locations of maps 804. In this example, the distance threshold is greater, so a larger distribution of POIs can be covered in a larger area. Further, there can be a greater amount of POIs, leading to the use of three maps, 804a, 804b, 804c. In this example, a horizontal layout is determined that is top heavy. As such, two maps, 804a, 804b are on the top side of the split while one map, 804c is on the bottom side of the split.

As the method 400 continues, a third iteration is performed yielding maps 806a, 806b. This iteration can include an even greater distance threshold. As such, the area covered by maps 806a, 806b is greater. This can also be attributed to a smaller concentration of POIs. For example, the POIs can be concentrated in the area of map 802 and maps 804a, 804b, 804c. This can indicate, for example, a downtown area of a city. In this example, the maps can be divided along a vertical split line between 806a and 806b. The amount of POIs can fit in two maps. In one example, the POIs in map 806a and 806b are determined from a set after the POIs in maps 802, 804a, 804b, and 804c are taken out of the set. As such, less overlap of maps can be possible.

Further, in this example, the zoom levels of the maps can be dependent on the size of the maps. As such, map 802 can be further zoomed in than maps 804a, 804b, and 804c. Additionally, maps 806a and 806b can be zoomed out more. Zoom levels can be based on the length and/or width of the maps compared to the availability of size on a layout of where the maps are presented.

FIG. 9 is a block diagram of a computing device for distributing points of interest of a set to maps based on a spread of the points of interest, according to one example. The computing device 900 includes, for example, a processor 910, and a machine-readable storage medium 920 including instructions 922-930 for distributing POIs to map sets. Computing device 900 may be, for example, a server, a workstation, a desktop computer, a notebook computer, or any other computing device.

Processor 910 may be, at least one central processing unit (CPU), at least one semiconductor-based microprocessor, at least one graphics processing unit (GPU), other hardware devices suitable for retrieval and execution of instructions stored in machine-readable storage medium 920, or combinations thereof. For example, the processor 910 may include multiple cores on a chip, include multiple cores across multiple chips, multiple cores across multiple devices (e.g., if the computing device 900 includes multiple node devices), or combinations thereof. Processor 910 may fetch, decode, and execute instructions 922, 924, 926, 928, 930 to implement methods 300 and 400. As an alternative or in addition to retrieving and executing instructions, processor 910 may include at least one integrated circuit (IC), other control logic, other electronic circuits, or combinations thereof that include a number of electronic components for performing the functionality of instructions 922-930.

Machine-readable storage medium 920 may be any electronic, magnetic, optical, or other physical storage device that contains or stores executable instructions. Thus, machine-readable storage medium may be, for example, Random Access Memory (RAM), an Electrically Erasable Programmable Read-Only Memory (EEPROM), a storage drive, a Compact Disc Read Only Memory (CD-ROM), and the like. As such, the machine-readable storage medium can be non-transitory. As described herein, machine-readable storage medium 920 may be encoded with a series of executable instructions for distributing POIs to map sets.

The computing device 900 can be used to implement a guide platform. The computing device 900 may receive a request for a customized guide from a client device. The computing device 900 can have access to customization information, for example, by receiving the customization information. POI grouping instructions 922 can determine POIs based on the customization information and/or location information. Location information can include a target area for which to determine the map sets for. As noted previously, customization information can include answers to a questionnaire or other preferences that can determine which POIs are relevant to the user. The POI grouping instructions can also cause the processor 910 to determine the locations of the POIs. Each of the POIs can be associated with horizontal coordinates and vertical coordinates. Various types of coordinates can be used, for example, GPS coordinates, longitude and latitude, etc.

To determine the map sets, distance instructions 924 can cause the processor 910 to determine a distance between each of the POIs and each of the other POIs. This information can be stored in a memory (e.g., a table data structure). The distance information can further be determined based on the horizontal and vertical coordinates and can be scaled.

The POI identification instructions 926 then cause the processor 910 to identify one of the POIs based on a number of POIs within a predetermined distance of the identified POI. The identified POI can be identified because the number of POIs within the predetermined distance is greater at the identified POI than at the other POIs. As noted above, various rules can be used to break ties. Further, other types of weighting can be used to determine the number, for example, the POIs can be weighted so that more relevant POIs count more.

Cluster selection instructions 928 then cause the processor 910 to select a set (e.g., a cluster) of the POIs within the predetermined distance of the identified POI. In other scenarios, the set can be based on the predetermined distance, for example, within a distance corresponding to a percentage of the predetermined distance.

Once the set is determined, distribution instructions 930 can cause the processor 910 to determine a horizontal spread based on vertical coordinates associated with the POIs of the set. Further, the processor 910 can be caused to determine a vertical spread based on the horizontal coordinates associated with the POIs of the set. The distribution instructions 930 can also cause the processor 910 to distribute the POIs of the set to one or more map sets based on a comparison of the horizontal spread and the vertical spread. As detailed above, the horizontal spread and the vertical spread can be used to determine a layout of the POIs in the map set. In certain embodiments, a map set is a group of the POIs that can be determined to fit within a map boundary. Based on the map sets, the computing device 900 can query a map platform for map information. The map information can include one or more maps based on the map sets. In one example, the maps can be determined by adding a border from the POIs on the edges of a map area corresponding to the map set. Further, these maps can be associated with a zoom-level. This can be determined based on the area covered by the respective maps.

As noted above, multiple iterations can be used to generate map sets for multiple sets of the POIs. Further, additional processing can be used after a map set is determined to add POIs that were determined based on the customization information but not included in the set that was distributed to one or more of the map sets. The cluster selection instructions 928 can cause the processor 910 to determine that one or more of the POIs not included in the set are within respective boundaries of the maps at the respective zoom-levels. The originally determined set and the one or more POIs can be included in an updated set.

The updated set can be reprocessed by the distribution instructions 930 to generate updated map sets. This can be accomplished by determining a second horizontal spread based on the vertical coordinates associated with the POIs of the updated set, determining a vertical spread based on the horizontal coordinates of the POIs of the updated set, and distributing the updated set of POIs based on the spreads. As such, the POIs of the updated set can be distributed to a plurality of other map sets based on a comparison of the second horizontal spread and the second vertical spread.

Then, map boundaries can be determined and generated for the map sets. The computing device 900 then requests associated maps from a map platform based on the map boundaries and/or the map sets. The maps can be incorporated into guide book information that can be presented to a user. The guide book information can be electronic and/or be in a printed format.

What is claimed is:

1. A method comprising:
determining a plurality of points of interest at a device;
identifying one of the points of interest based on a distance analysis of the points of interest;
determining a cluster of the points of interest; and
distributing the points of interest within the cluster to a plurality of maps based on a statistical analysis.

2. The method of claim 1, further comprising:
determining, for each of the points of interest, respective numbers of the points of interest within a distance of other respective points of interest,
wherein the one point of interest is identified based on a determination that the number associated with the one point of interest is greater than or equal to the other respective numbers.

3. The method of claim 2, wherein the points of interest in the cluster are within the distance from the one point of interest.

4. The method of claim 1, wherein each of the points of interest of the cluster correspond to a horizontal coordinate and a vertical coordinate, the method further comprising:
determining a horizontal spread based on the vertical coordinates; and
determining a vertical spread based on the horizontal coordinates,
wherein the distribution of the points of interest of the cluster to the maps is based on the horizontal spread and the vertical spread.

5. The method of claim 4, further comprising:
determining a count of the maps based on a maximum number of the points of interest to associate with the respective maps.

6. The method of claim 5, further comprising:
determining a directional split based on the horizontal spread and the vertical spread,
wherein the count of the maps is split proportionately around the directional split.

7. The method of claim 6, further comprising:
determining that the count is odd; and
determining a weighting of the points of interest in relation to the directional split,
wherein a side of the directional split with a greater weighting has more of the maps than the other side of the directional split.

8. The method of claim 1, further comprising:
determining a set of the points of interest not included in the cluster;
identifying a first one of the points of interest of the set based on distance analysis of the points of interest in the set;
determining another cluster including the points of interest of the set that are within a particular distance of the first one set point of interest; and
distributing the points of interest of the other cluster to a plurality of other maps based on another statistical analysis.

9. The method of claim 1, further comprising:
determining the maps; and
generating book information including the maps with the respectively distributed points of interest and content respectively describing the distributed points of interest.

10. A device comprising:
a distance module to determine a distance between each of a plurality of points of interest with each of the other points of interest, wherein the points of interest are respectively associated with coordinates;
a selection module to select one point of interest from the points of interest;
a cluster module to determine a cluster of the points of interest that is within a predetermined distance of the one point of interest;
a map determination module to determine an amount of maps to distribute the cluster points of interest; and
a distribution module to distribute the cluster points of interest to a plurality of maps based on a statistical analysis.

11. The device of claim 10, wherein the respective coordinates of the cluster points of interest each include a horizontal coordinate and a vertical coordinate, the device further comprising:
a statistical analysis module to:
determine a horizontal standard deviation based on the vertical coordinates and a vertical standard deviation based on the horizontal coordinates, and
determine a split of the cluster points of interest based on the horizontal standard deviation and the vertical standard deviation,
wherein the distribution of the cluster points of interest to the maps is based on the split.

12. The device of claim 10, further comprising:
a book module to generate guide book information including the maps, wherein each map shows its distributed points of interest, the guide book information further comprising description information for each of the points of interest.

13. A non-transitory machine-readable storage medium storing instructions that, if executed by a processor of a device, cause the processor to:
determine a plurality of points of interest, wherein the respective points of interest are associated with respective horizontal coordinates and respective vertical coordinates;
determine a distance between each of the points of interest and each of the other points of interest;
identify one of the points of interest based on a number of the points of interest within a predetermined distance of the one point of interest;
select a set of the points of interest within the predetermined distance of the one point of interest;
determine a horizontal spread based on the vertical coordinates associated with the points of interest of the set;
determine a vertical spread based on the horizontal coordinates associated with the points of interest of the set; and
distribute the points of interest of the set into a plurality of map sets based on a comparison of the horizontal spread and the vertical spread.

14. The non-transitory machine-readable storage medium of claim 12, further comprising instructions that, if executed by the processor, cause the processor to:
receive customization information, wherein the points of interest are determined based on the customization information; and
query map information from a map platform, wherein the map information includes one or more maps based on the map sets.

15. The non-transitory machine-readable storage medium of claim 14,
wherein the maps are respectively associated with a zoom-level,
wherein non-transitory machine-readable storage medium further comprises instructions that, if executed by the processor, cause the processor to:
determine that one or more of the points of interest not included in the set are within respective boundaries of the maps at the respective zoom-levels;
include the set and the one or more points of interest in an updated set;
determine a second horizontal spread based on the vertical coordinates associated with the points of interest of the updated set;
determine a second vertical spread based on the horizontal coordinates associated with the points of interest of the updated set; and
distribute the points of interest of the updated set to a plurality of other map sets based on a comparison of the second horizontal spread and the second vertical spread.
